(19) United States
(12) Patent Application Publication
(10) Pub. No.: US 2009/0163239 A1
(43) Pub. Date: Jun. 25, 2009

(54) METHOD, APPARATUS AND COMPUTER PROGRAM PRODUCT FOR GENERATING MEDIA CONTENT BY RECORDING BROADCAST TRANSMISSIONS

(75) Inventors: Eustachio Epifania, Nivaa (DK); Per Aae Rasmussen, Holte (DK); Miky Hsu, Copenhagen (DK); Kristian Schultz, Copenhagen (DK); Brian Jensen, Smoerum (DK); Harri Tunturivuori, Malmo (SE); Martin Johansen, Copenhagen (DK); Christian Hedegaard, Valby (DK); Jens Kaas Benner, Copenhagen (DK); Christian Rossing Kraft, Frederiksberg (DK); Peter Dam Nielsen, Kgs Lyngby (DK); Ditte Flamsholt, Frederiksberg (DK); Jennica Falk, Copenhagen (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/962,291

(22) Filed: Dec. 21, 2007

(51) Int. Cl. H04M 1/00

(52) U.S. Cl. 455/550.1

(57) ABSTRACT

An apparatus for enabling generation of media content by recording broadcast transmissions may include a processing element. The processing element may be configured to record content associated with a broadcast transmission at a mobile terminal, assign an informational tag to the recorded content without user interaction during the assigning, and store the recorded content in association with the informational tag.

### TECHNOLOGICAL FIELD

Embodiments of the present invention relate generally to content generation technology and, more particularly, relate to a method, apparatus and computer program product for generating media content by recording broadcast transmissions.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices with respect to managing, creating and consuming multimedia content. Due to the ubiquitous nature of mobile communication devices, people all over the world and of all walks of life are now utilizing mobile terminals to communicate with other individuals, entities or contacts and/or to share or consume information, media and other content. Additionally, given recent advances in processing power, battery life, memory and the availability of peripherals such as video/audio recording and playback, mobile terminals are becoming prolific producers and consumers of media. Content for consumption by a particular user may be acquired in numerous forms and via numerous mechanisms. For example, it is currently popular to download music, videos and other content in various formats such as MP3 (Moving Picture Experts Group (MPEG)-1 audio layer 3) via a computer or the Internet. However, in some locations, and for some users regardless of their location, access to computers and/or the Internet may not be physically or economically practicable. Thus, the acquisition of content may be difficult for such users. Moreover, although content can also be shared or acquired via, for example, sending MP3s or other media content files over Bluetooth or other communications mechanisms such peer-to-peer (P2P) content sharing, many users may not desire or have access to mobile terminals having the capability for certain modes of communication.

Accordingly, it may be desirable to provide another mechanism by which mobile terminal users may acquire media content, which may overcome at least some of the disadvantages described above.

### BRIEF SUMMARY

A method, apparatus and computer program product are therefore provided to enable the generation of media content from a recording of broadcast content. In particular, a method, apparatus and computer program product are provided that may enable the recording of content associated with a broadcast transmission at a device such as a mobile terminal along with the creation and assignment of an informational tag to the recorded content. The informational tag may be assigned without user interaction during the assigning, although the user may modify the tag after the tag's creation and/or provide rules to govern creation of the tag. The recorded content may then be stored in association with the informational tag and a playlist can be generated and/or presented to the user based on the recorded content. Accordingly, a user can acquire content for consumption and/or sharing even if access to computers, the Internet, and/or highly evolved devices is not available or desired.

Embodiments of the invention may provide a method, apparatus and computer program product for advantageous employment in mobile environments, such as on a mobile terminal capable of rendering content items related to various types of media. As a result, for example, mobile terminal users may enjoy an improved content management capability and a corresponding improved ability to acquire and experience content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for enabling generation of media content from a broadcast transmission according to an exemplary embodiment of the present invention;

FIG. 4 illustrates an example of a graphical user interface that may be associated with a media player according to an exemplary embodiment of the present invention;

FIG. 5 illustrates another example of a graphical user interface that may be associated with the media player according to an exemplary embodiment of the present invention;

FIG. 6 illustrates still another example of a graphical user interface that may be associated with the media player according to an exemplary embodiment of the present invention;

FIG. 7 illustrates an example of a graphical user interface for enabling selection of radio content for recording according to an exemplary embodiment of the present invention; and

FIG. 8 is a flowchart according to an exemplary method for generating media content by recording broadcast transmissions according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

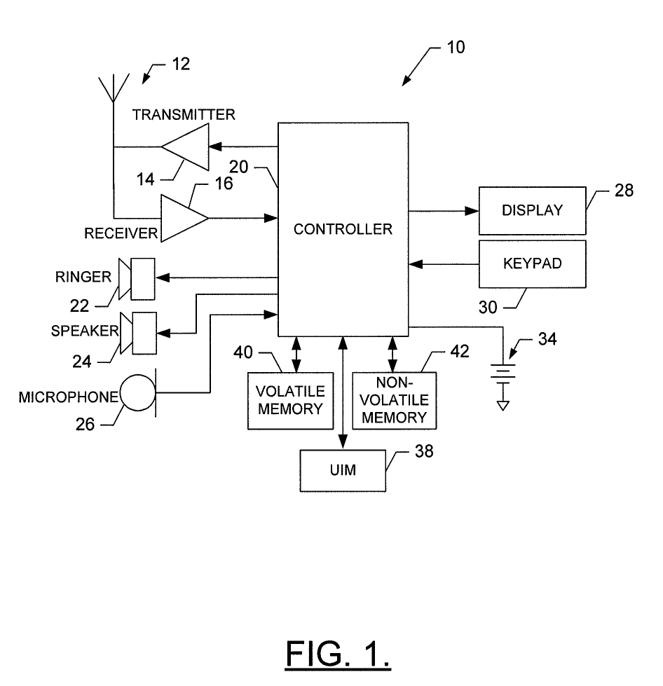

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, tablets, internet capable devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the apparatus such as the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

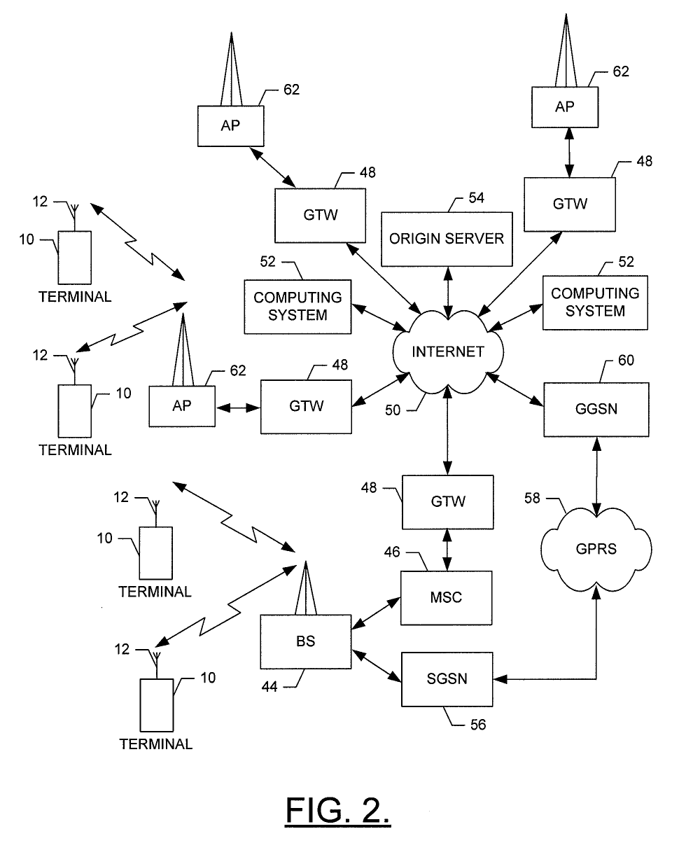

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content acquisition or sharing) between the mobile terminal 10 and other mobile terminals or network devices. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

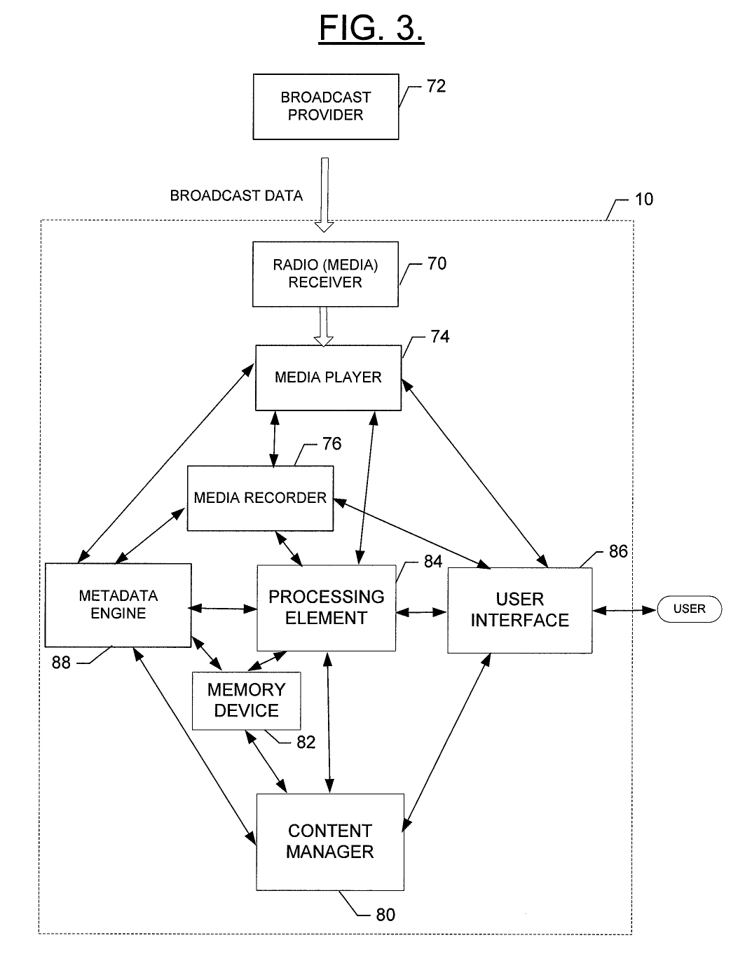

An exemplary embodiment of the invention will now be described with reference to FIG. 3, in which certain elements of a system for enabling generation of media content by recording broadcast transmissions are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. As an example of devices other than the mobile terminal of FIG. 1, the system of FIG. 3 may be employed on a personal computer, a camera, a video recorder, a handheld computer, a server, a proxy, etc. Alternatively, embodiments may be employed on a combination of devices including, for example, those listed above. It should also be noted that while FIG. 3 illustrates one example of a configuration of a system for enabling generation of media content by recording broadcast transmissions, for example, in a mobile environment, numerous other configurations may also be used to implement embodiments of the present invention. As such, it should be noted that the devices or elements described below may not be mandatory and thus some may be omitted in certain embodiments.

Referring now to FIG. 3, a system for enabling generation of media content by recording broadcast transmissions is provided. The system may include a combination of entities or devices that may be embodied in hardware, software or a combination of hardware and software for use in connection with embodiments of the present invention. Although an embodiment will be described below in the context of radio broadcast transmission as the media type, other types of media may also be utilized in accordance with embodiments of the present invention.

In one example, embodiments of the present invention may be practiced by a device such as the mobile terminal 10 including a radio receiver 70 in communication with a broadcast provider 72. The broadcast provider 72 may be, for example, a radio station providing terrestrial radio signals, a satellite radio provider, or an Internet radio provider transmitting radio broadcast information. However, video or television broadcast transmissions could alternatively or additionally be provided by the broadcast provider 72. The radio receiver 70 may be any device or means embodied in hardware, software or a combination of hardware and software that is configured to receive and/or process broadcast transmissions from the broadcast provider 72. Thus, for example, if the broadcast provider 72 is a terrestrial radio station, the radio receiver 70 may include an AM (amplitude modulation) and/or FM (frequency modulation) band radio receiver and/or tuner. Similarly, if the broadcast provider 72 is a satellite radio provider, the radio receiver 70 may be a satellite radio receiver. Meanwhile, if the broadcast provider 72 is an Internet radio provider, then the radio receiver 70 may be configured to receive and process signals received, for example, via the system of FIG. 2 or via a wired connection to the Internet.

In an exemplary embodiment, in addition to the radio receiver 70, a device employing embodiments of the present invention (e.g., the mobile terminal 10) may include a media player 74, a media recorder 76, a content manager 80, a memory device 82, processing element 84 and a user interface 86. In exemplary embodiments, various ones of the media player 74, the media recorder 76, the content manager 80, the memory device 82, the processing element 84 and the user interface 86 may be in communication with each other via any wired or wireless communication mechanism. Moreover, any or all of the media player 74, the media recorder 76, the content manager 80, the memory device 82, the processing element 84 and the user interface 86 may be collocated in a single device (e.g., the mobile terminal 10). However, one or more of the media player 74, the media recorder 76, the content manager 80, the memory device 82, the processing element 84 and the user interface 86 could alternatively be located in a different device such as, for example, a device that may be placed in communication with other ones of the elements listed above. For example, in one embodiment, the memory device 82 may be embodied as a removable memory card (e.g., a flash memory or other hot pluggable storage medium). It should be noted that not all of the elements described above may be required to practice embodiments of the present invention. Furthermore, some of the elements described above may be controlled by or otherwise embodied as the processing element 84 (e.g., the media player 74, the media recorder 76, the content manager 80, and/or the user interface 86).

In general terms, the system of FIG. 3 may enable a user to render a broadcast transmission (e.g., radio broadcast information) via the media player 74 and simultaneously record a content item corresponding to the broadcast transmission via the media recorder 76. The content item may be stored in the memory device 82 (e.g., via user input using the user interface 86) and selected for playback at a later time. Furthermore, the content item may be stored in connection with an informational tag (or tags) as described in greater detail below.

In this regard, according to an exemplary embodiment, the system may also include a metadata engine 88, which may be embodied as or otherwise controlled by the processing element 84. The metadata engine 88 may be configured to assign metadata or informational tags (e.g., ID tags) to each content item created for storage (e.g., by the media recorder 76 at the memory device 82. In an exemplary embodiment, the metadata engine 88 may be in simultaneous communication with one or more devices or applications and may generate metadata for content created by each corresponding device or application. In an exemplary embodiment, the metadata engine 88 may be in communication with the media player 74 and/or the media recorder 76 in order to generate informational tags including or indicative of information defining a characteristic of a content item being rendered by the media player 74 and/or recorded by the media recorder 76.

The metadata engine 88 may be any device or means embodied in either hardware, software, or a combination of hardware and software configured to generate an informational tag for a particular content item according to a defined set of rules. The defined set of rules may dictate, for example, the informational tag that is to be assigned to content created using a particular application/device or in a particular context, etc. As such, in response to receipt of an indication of an event such as recording of a content item, the metadata engine 88 may be configured to assign corresponding metadata (e.g., the informational tag). The metadata engine 88 may alternatively or additionally handle all metadata for the content items, so that the content items themselves need not necessarily be loaded, but instead, for example, only the metadata file or metadata entry/entries associated with the corresponding content items may be loaded in a database.

Metadata or informational tags typically include information that is separate from an object, but related to the object. An object may be “tagged” by adding metadata or a tag to the object. As such, an informational tag may be used to specify properties, features, attributes, or characteristics associated with the object that may not be obvious from the object itself. Informational tags may then be used to organize the objects to improve content management capabilities. Additionally, some methods have been developed for inserting metadata based on context. Context metadata describes the context in which a particular content item was “created”. Hereinafter, the term “created” should be understood to be defined such as to encompass also the terms captured, received, and downloaded. In other words, content is defined as “created” whenever the content first becomes resident in a device, by whatever means regardless of whether the content previously existed on other devices. However, some context metadata may also be related to the original creation of the content at another device if the content is downloaded or transferred from another device. Context metadata can be associated with each content item in order to provide an annotation to facilitate efficient content management features such as searching and organization features. Accordingly, the context metadata may be used to provide an automated mechanism by which content management may be enhanced and user efforts may be minimized.

Metadata or informational tags are often textual keywords used to describe the corresponding content with which they are associated. In various examples, an informational tag may identify a radio channel from which a particular content item was recorded, a program name, a time/date of recording, genre, program type, etc. In an exemplary embodiment, the metadata engine 88 may be further configured to enable a user, either at the time of recording of the content item, or at a later time, to modify the informational tag for using the user interface 86. In some embodiments, user added or modified informational tags may form a rich source of determining attributes upon which to base content organization or selection since the user tags may be likely to indicate real relationships that may be appreciated by the user. The metadata engine 88 may also enable the user to define rules for automatic insertion of informational tags for new content. Such rules may also be defined by default settings which may or may not be changeable by the user. In any case, the rules may define a particular format for the informational tags and/or particular prefixes, suffixes, or other characteristics of the informational tags, which may be assigned in defined instances or on recordings of a particular type of media or format of data.

The media player 74 may include any of a number of different devices configured to provide playback and/or rendering capabilities with respect to media content or files. For example, the media player 74 may include a television (TV) monitor, video playback device, audio playback device, etc. In some embodiments, the media player 74 may be embodied as a virtual machine or software application for rendering or playing back multimedia files via the display and/or speaker of the mobile terminal 10. As such, for example, the media player 74 may be configured to render audio and/or video data such as in a particular audio or video file that may be recorded at the mobile terminal 10 for rendering via the media player 74. However, it should be noted that by reference to content items being rendered or played, it should not be assumed that such rendering results in an audible or visible production by the media player 74. Rather, the media player 74 may merely process broadcast transmission signals to generate an output capable of audible or visible consumption by a user. In an exemplary embodiment, the media player 74 may enable a user to listen to radio broadcast information (e.g., music, talk radio, commercials, etc.) on a particular (e.g., tuned-in) AM or FM radio channel.

The media recorder 76 may be in communication with the media player 74 to enable the media recorder 76 to record a content item that is being processed or rendered at the media player 74. As such, the media recorder 76 may include any number of different devices and/or applications configured to record content to a computer readable storage medium such as the memory device 82. Thus, the media recorder 76 may be any means such as a device or circuitry embodied in hardware, software or a combination of hardware and software that is configured to record broadcast transmission data that is being rendered at the media player 74 or captured by the media recorder 76, for example, via the microphone 26.

In an exemplary embodiment, the media recorder 76 may include a capability to record data at different quality levels, which may depend, for example, on the type of media being recorded or the mechanism for recording. For example, if the media content being recorded is radio broadcast data, the media player 74 (e.g., a radio player) may tune into a particular FM radio station and the media recorder 76 may record the radio broadcast data as a media content item in a relatively high quality format (e.g., WAV (waveform audio) format). Meanwhile, for example, if the media content being recorded is radio broadcast data or speech of the user or some other individual, the media recorder 76 may capture the sound corresponding to the radio broadcast data or speech (e.g., from a speaker) via the microphone 26 and record such data or speech via another quality level format (e.g., AMR format (adaptive multi-rate audio compression)). In an exemplary embodiment, file names and/or icons may be associated with content items based on the quality level of the recording and/or the type of media content. For example, AMR recordings and WAV recordings may each have distinct file naming conventions and icons associated therewith.

The memory device 82 (e.g., the volatile memory 40 or the non-volatile memory 42) may be configured to store a plurality of content items and/or informational tags associated with each of the content items. The memory device 82 may store content items of either the same or different types. In an exemplary embodiment, different types of content items may be stored in separate folders or separate portions of the memory device 82. However, content items of different types could also be commingled within the memory device 82 or within folders of the memory device 82. For example, one folder within the memory device 82 could include content items related to types of content such as music, broadcast content (e.g., from the Internet and/or radio stations), video/audio content, etc. Alternatively, separate folders may be dedicated to each type of content. For example, a music library may be designated to receive content items associated with radio recordings.

In an exemplary embodiment, a user may utilize the user interface 86 to initiate a rendering of content at the media player 74 and/or to initiate a storing of content in the memory device 82 by the media recorder 76, for example, via the processing element 84. The processing element 84 (e.g., the controller 20) may be in communication with or otherwise execute an application configured to display, play or otherwise render a selected content item or broadcast content via the user interface 86. Processing elements such as those described herein may be embodied in many ways. For example, the processing element may be embodied as a processor, a coprocessor, a controller or various other processing means or devices including integrated circuits such as, for example, an ASIC (application specific integrated circuit).

The user interface 86 may include, for example, the microphone 26, the speaker 24, the keypad 30 and/or the display 28 and associated hardware and software. The user interface 86 may also include a mouse, scroller or other input mechanism. In this regard, the user interface 86 may alternatively be embodied entirely in software, such as may be the case when a touch screen is employed for interface using functional elements such as software keys accessible via the touch screen using a finger, stylus, etc. Alternatively, proximity sensors may be employed in connection with a screen such that an actual touch need not be registered in order to perform a corresponding task. Speech input could also or alternatively be utilized in connection with the user interface 86. As another alternative, the user interface 86 may include a simple key interface including a limited number of function keys, each of which may have no predefined association with any particular text characters. As such, the user interface 86 may be as simple as a display and/or speaker and one or more keys for selecting a highlighted option on the display for use in conjunction with a mechanism for highlighting various menu options on the display prior to selection thereof with the one or more keys. User instructions for the performance of a function may be received via the user interface 86 and/or an output such as by visualization, display, playback or rendering of content may be provided via the user interface 86.

The content manager 80 may be embodied as any device or means embodied in either hardware, software, or a combination of hardware and software that is capable of performing the corresponding functions of the content manager 80 as described in greater detail below. In an exemplary embodiment, the content manager 80 may be controlled by or otherwise embodied as the processing element 84 (e.g., the controller 20 or a processor of a computer or other device).

In an exemplary embodiment, the content manager 80 may be configured to arrange content items into a playlist and/or enable selection or manipulation of content items in a gallery. In this regard, for example, the user may utilize the user interface 86 to arrange content items into one or more playlists that may be stored, for example, in the memory device 82. As such, for example, individual content items may be selected from a folder or gallery and placed in a desired location or ordering within a playlist. The playlist may be given a title that may be indicative of, for example, a theme of the playlist. The content manager 80 may also be configured to arrange content items, e.g., either within a folder or gallery, based on the informational tags associated with the content items. For example, the content manager 80 may be configured to associate content items having particular informational tags into a corresponding particular gallery.

In an exemplary embodiment, the content manager 80 (e.g., under the control of the processing element 84) may be configured to obtain radio data system (RDS) information from radio broadcast data, which may, for example, be communicated to the metadata engine 88 for use in informational tag creation. RDS information includes several types of standard information transmitted along with other content in radio broadcast data. In this regard, for example, RDS information may include time, track/artist information, station identification, etc. Accordingly, the metadata engine 88 may utilize the RDS information to automatically assign the informational tag based on, for example, the time, track, artist and/or station. In an exemplary embodiment, the content manager 80 may also utilize the RDS information to determine the start and end points of music tracks. Thus, for example, if the media player 74 is tuned to a particular radio station and the media recorder 76 has been instructed to record broadcast transmission data from the particular radio station, the content manager 80 may identify the start and end of music tracks to the media recorder 76. Accordingly, the media recorder 76 may record each music track as a separate content item within the context of all of the recorded data. Thus, despite being set for continuous recording of the broadcast transmission data of the particular radio station, the media recorder 76 may, e.g., with assistance from the content manager 80, define a plurality of content items each of which corresponds to one of the music tracks rather than recording one large content item including multiple music tracks. However, if desired, the media recorder 76 may also record a single content item corresponding to a period of recording time that may include, for example, multiple music tracks or talk radio segments.

In an alternative embodiment, rather than using RDS information to determine the start and end of music tracks, the content manager 80 may further be configured to detect differences between music and other segments (e.g., talking or commercial segments) by analysis of the broadcast transmission data. Accordingly, when changes or breaks in the music or speech occur, segments may be defined to identify separate content items. The identification of separate content items may be performed whether the media recorder 76 is recording received data rendered at the media player 74 or sounds recorded via the microphone 26. Content items, regardless of whether they correspond to single music tracks or other types of media (e.g., video clips, voice clips, etc.) may thereafter be stored in the memory device 82 in association with any informational tag that may have been created to be assigned therewith. As indicated above, the user interface 86 may be in communication with at least the content manager 80 and/or the media player 74 to enable the generation of a display of content items that may be rendered and which are stored in the memory device 82, or a display of content items currently being recorded. As such, the media player 74 may be configured to provide, for example, a control console or other functional control mechanism via the user interface 86, which may enable the user to utilize the elements and/or devices described above to practice embodiments of the present invention.

In an exemplary embodiment, the content manager 80 may be further configured to compare RDS information and/or informational tags of existing content items to a currently recording content item or to broadcast data that could be recorded (e.g., broadcast data being rendered on the media player 74). In this regard, if the content manager 80 determines that a currently recording content item matches an existing content item, the current recording may be stopped and recorded portions may be deleted. However, in some embodiments, the user may be prompted and asked for instructions on how to proceed. Alternatively, if the content manager 80 determines that broadcast data currently being rendered matches an existing content item stored in the memory device 82, the content manager 80 may provide that the media recorder 76 does not record the broadcast data. In one embodiment, the media player 74, the content manager 80 or the media recorder 76 may include or have access to a temporary buffer to buffer data for use by the content manager 80 in making comparisons to existing data. Accordingly, if a decision to record data is made after the comparison, data may be recorded to the memory device 82 by the media recorder 76 without losing the information initially recorded in the temporary buffer and without starting a recording directly to the memory device 82. Meanwhile, if a decision is made not to record data based on the comparison, data need never be recorded to the memory device 82 since the information initially recorded in the temporary buffer may simply be recorded over during later operations.

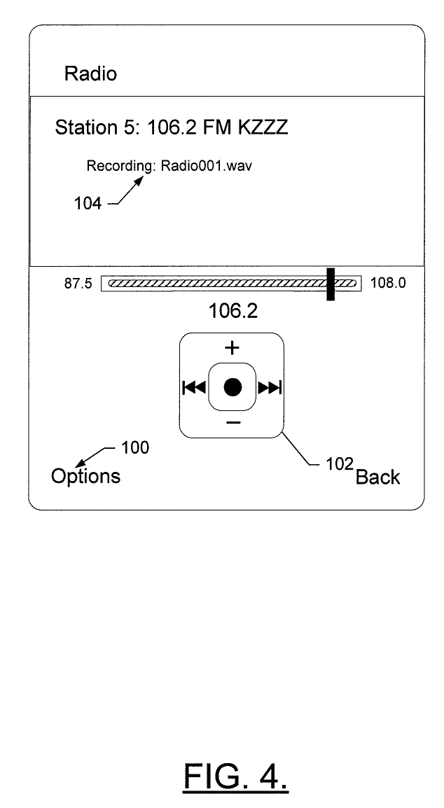

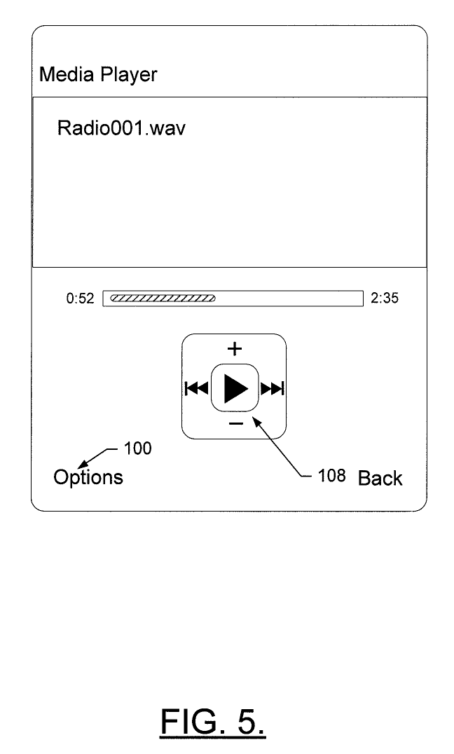

In this regard, FIGS. 4-7 illustrate examples of a graphical user interface that may be associated with the media player 74 according to an exemplary embodiment. As shown in FIG. 4, a graphical user interface (GUI) associated with the media player 74 may indicate for which corresponding type or mode of media rendering (e.g., radio player) the media player is currently configured. The GUI may also indicate a particular broadcast channel currently being monitored and, for example, the position of the particular broadcast channel relative to the available band of frequencies that may be monitored. In an exemplary embodiment, the GUI may also include an options menu section option 100 and/or a selectable object 102 (e.g., a record button) that, when selected, may enable the recording of media currently being rendered. The object 102 may also include other selectable functions (e.g., volume control, seek functions, etc.) although such functions could alternatively be included as part of separate selectable objects. The functions may be selected via a dedicated or soft key, via a scroll function, via selection on a touch screen display, or numerous other known mechanisms. If a recording is in progress (e.g., using the media recorder 76) the GUI may be updated to indicate that a recording is in progress and/or the data being recorded may be identified as indicated by recording indications 104. If the recording is in progress, the record button may be changed to a stop button, which when selected may stop the current recording. When recorded data is being played, the GUI may be, for example, as shown in FIG. 5. As illustrated in FIG. 5, a play selection object 108 may be utilized to control certain functions of the media player 74 in playback mode.

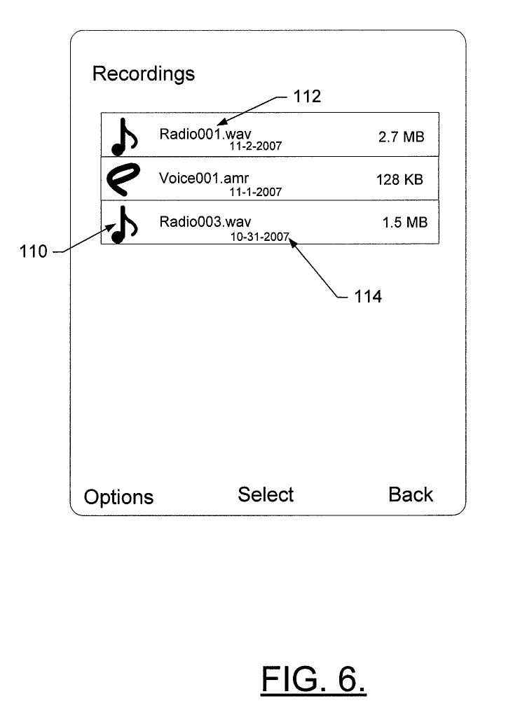

Selection of the options menu may provide a list of further accessible functions which could include items corresponding to, for example, galleries, folders, viewing and/or editing of informational tags, instructions for arrangement of content items, creation and/or selection of a playlist, etc. Upon selection of an option corresponding to a request to view content items, a listing of content items (e.g., as shown in FIG. 6) may be displayed. As shown in FIG. 6, each of the content items may include an icon 110 and/or file format (which may be indicated as part of the file name 112) that corresponds to the media type and/or quality of the recording. Each of the content items of FIG. 6 may also include a corresponding informational tag 114. However, it should be appreciated that although the informational tags shown in FIG. 6 merely illustrate a date of the recording, the informational tags could include many other types of information as indicated above. If any one of the content items in the list is selected, the selected content item may be rendered via the media player 74, either directly or via selection of a further option that may be presented. Furthermore, the GUI may be updated to provide indications with regard to identifying that a content item is being played (or recorded) and/or identifying the content item being played (or recorded).

In an exemplary embodiment, the GUI may also provide indications of certain events using pop up windows, icons, alarms, and/or other visual, mechanical or audible indicators. For example, if a call is received during the rendering of a content item, an alarm and/or pop up, etc., may announce the call. The user may ignore the call and continue recording or switch to the call (e.g., by selecting the pop up or a link displayed on the GUI, or by selecting a particular soft key). Other visual and/or audible indicators may be provided with respect to events such as insufficient memory to initiate a recording, running out of memory space during a particular recording, identifying a content item as having below a threshold minimum size (e.g., less than 1 second long), receipt of an email or SMS, etc.

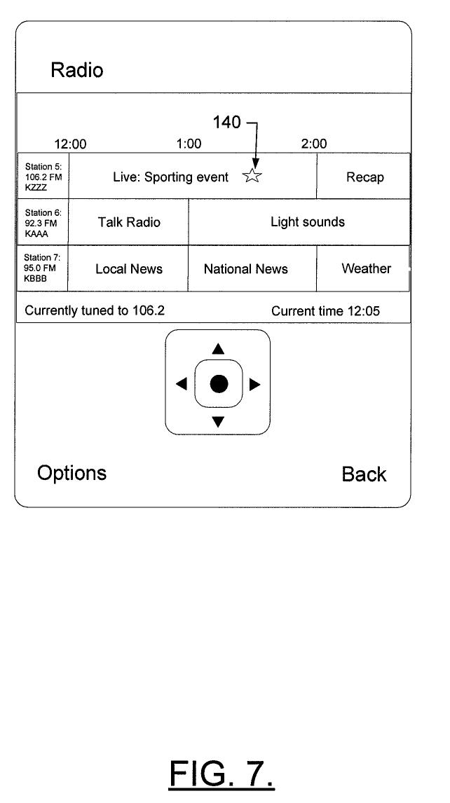

FIG. 7 illustrates an example of a graphical user interface for enabling selection of radio content for recording according to an exemplary embodiment of the present invention. In this regard, as shown in FIG. 7, a user may be enabled to view upcoming programming for a particular radio broadcast channel (or channels). From the upcoming programming schedule, the user may navigate to or otherwise select a particular upcoming program. In some embodiments, selection of the particular upcoming program may permit viewing of detailed information regarding the upcoming program. The user may be enabled, for example, by selection of a particular function key or selection of a menu option, to record any of the programs in the upcoming programming schedule (or a currently running program). Accordingly, if a particular upcoming program is selected for recording, a switch (if necessary) to the corresponding channel may be initiated prior to the scheduled start of the particular upcoming program. Similarly, if a currently running program is selected for recording, a switch (if necessary) to the corresponding channel may be initiated upon receipt of the instruction to record the currently running program. An icon 150 or other indicator may be provided for association with a program being recorded, so that the user can easily see which, if any, program is being recorded at any given time. The icon 150 could alternatively or additionally be associated with a program that is scheduled to be recorded in the future.

Information regarding current and future programming may be collected in numerous ways. For example, current programming may be determined based on a scan of channels for corresponding RDS information for each of the channels. However, current and future programming information may be acquired from a program guide if the channels are internet or satellite radio channels. Programming information may also be acquired by a service (e.g., provided by a server or other network device), which may acquire programming information directly from corresponding radio stations or from the websites of each corresponding radio station. As yet another alternative, an application may be provided and executed locally for downloading radio station programming information from corresponding radio station websites. In another alternative embodiment, an application may track RDS information for various channels which are tuned in over time. The application may compare the RDS information with respective times of the programming over time in order to determine programming information based on correlations that may be made as a result of the comparison. Users may also share programming information between each other.

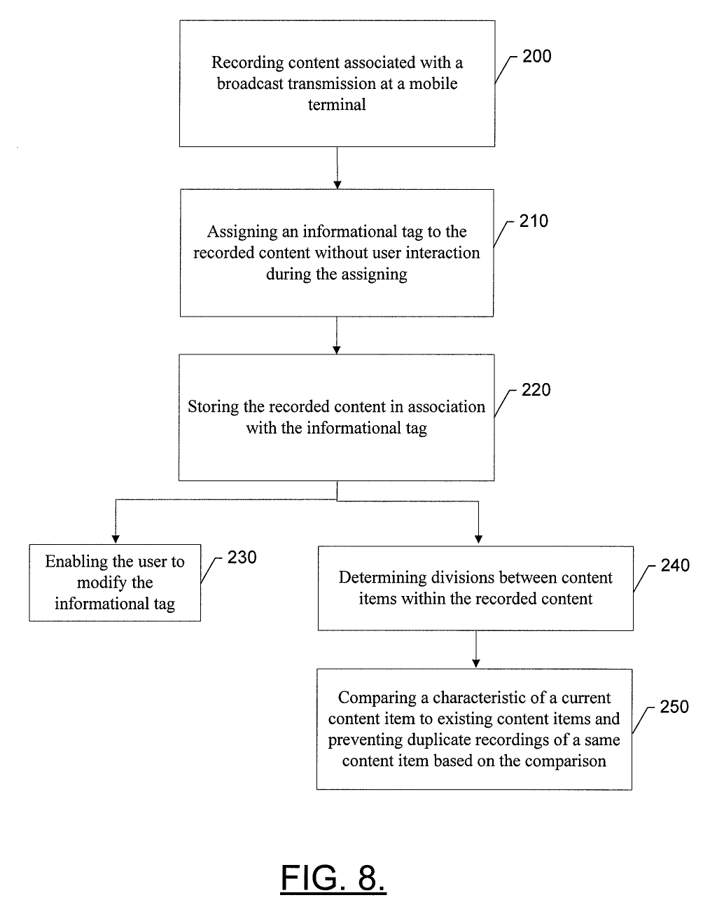

FIG. 8 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for enabling generation of media content items by recording broadcast transmissions as illustrated, for example, in FIG. 8 may include recording content associated with a broadcast transmission at a mobile terminal at operation 200. At operation 210, an informational tag may be assigned to the recorded content without user interaction during the assigning. The recorded content may then be stored in association with the informational tag at operation 220. The storage may occur, for example, at a memory device of the mobile terminal or at a removable memory card. In one embodiment, the recorded content may include a plurality of content items. As such, for example, a playlist may be generated including at least a portion of the content items.

In an exemplary embodiment, the method may include further optional operations. In this regard, for example, the method may include enabling the user to modify the informational tag at operation 230. Alternatively, the method may include determining divisions between content items within the recorded content at operation 240. In such a situation, assigning the informational tag may further include assigning a corresponding separate tag to each of the content items. At operation 250, a characteristic (e.g., RDS information) relating to a current content item may be compared to a corresponding characteristic of one or more existing content items and duplicate recordings of a same content item may be prevented based on the comparison. In an exemplary embodiment, the broadcast transmission may be a radio transmission and assigning the informational tag may include assigning information indicative of a radio station from which the transmission was received or a time at which the recording was performed. The method may further include presenting content items, and/or the corresponding informational tag(s) for each content item, to the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
recording content associated with a broadcast transmission at a mobile terminal;
assigning an informational tag to the recorded content without user interaction during the assigning; and
storing the recorded content in association with the informational tag.

2. A method according to claim 1, further comprising enabling the user to modify the informational tag.

3. A method according to claim 1, wherein the recorded content includes a plurality of content items and wherein the method further comprises generating a playlist including at least a portion of the content items.

4. A method according to claim 1, wherein storing the recorded content comprises storing the recorded content in a memory device of the mobile terminal.

5. A method according to claim 1, wherein storing the recorded content comprises storing the recorded content in a removable memory device.

6. A method according to claim 1, wherein the broadcast transmission is a radio transmission and wherein assigning the informational tag comprises assigning information indicative of a radio station from which the transmission was received or a time at which the recording was performed.

7. A method according to claim 1, further comprising determining divisions between content items within the recorded content, wherein assigning the informational tag further comprises assigning a corresponding separate tag to each of the content items.

8. A method according to claim 7, further comprising comparing a characteristic of a current content item to existing content items and preventing duplicate recordings of a same content item based on the comparison.

9. A computer program product comprising at least one computer-readable storage medium having computer-readable program code portions stored therein, the computer-readable program code portions comprising:
a first executable portion for recording content associated with a broadcast transmission at a mobile terminal;
a second executable portion for assigning an informational tag to the recorded content without user interaction during the assigning; and
a third executable portion for storing the recorded content in association with the informational tag.

10. A computer program product according to claim 9, further comprising a fourth executable portion for enabling the user to modify the informational tag.

11. A computer program product according to claim 9, wherein the recorded content includes a plurality of content items and wherein the computer program product further comprises a fourth executable portion for generating a playlist including at least a portion of the content items.

12. A computer program product according to claim 9, wherein the third executable portion includes instructions for storing the recorded content in a memory device of the mobile terminal.

13. A computer program product according to claim 9, wherein the third executable portion includes instructions for storing the recorded content in a removable memory device.

14. A computer program product according to claim 9, wherein the broadcast transmission is a radio transmission and wherein the second executable portion includes instructions for assigning an information tag indicative of a radio station from which the transmission was received or a time at which the recording was performed.

15. A computer program product according to claim 9, further comprising a fourth executable portion for determining divisions between content items within the recorded content, wherein the second executable portion includes instructions for assigning a corresponding separate tag to each of the content items.

16. A computer program product according to claim 15, further comprising a fifth executable portion for comparing a characteristic of a current content item to existing content items and preventing duplicate recordings of a same content item based on the comparison.

17. An apparatus comprising a processor configured to:
record content associated with a broadcast transmission at a mobile terminal;
assign an informational tag to the recorded content without user interaction during the assigning; and
store the recorded content in association with the informational tag.

18. An apparatus according to claim 17, wherein the processor is further configured to enable the user to modify the informational tag.

19. An apparatus according to claim 17, wherein the recorded content includes a plurality of content items and wherein the processor is further configured to generate a playlist including at least a portion of the content items.

20. An apparatus according to claim 17, wherein the processor is further configured to store the recorded content in a memory device of the mobile terminal.

21. An apparatus according to claim 17, wherein the processor is further configured to store the recorded content in a removable memory device.

22. An apparatus according to claim 17, wherein the broadcast transmission is a radio transmission and wherein the processor is further configured to assign information indicative of a radio station from which the transmission was received or a time at which the recording was performed.

23. An apparatus according to claim 17, wherein the processor is further configured to determine divisions between content items within the recorded content, and to assign a corresponding separate tag to each of the content items.

24. An apparatus according to claim 23, wherein the processor is further configured to compare a characteristic of a current content item to existing content items and prevent duplicate recordings of a same content item based on the comparison.

25. An apparatus comprising:
means for recording content associated with a broadcast transmission at a mobile terminal;
means for assigning an informational tag to the recorded content without user interaction during the assigning; and
means for storing the recorded content in association with the informational tag.

26. A user interface generated in accordance with instructions stored in a computer readable storage medium, the user interface comprising:
an indication of at least one radio broadcast station from which content may be received;
a schedule of programming associated with the radio broadcast station comprising at least a current program and a future program scheduled to be transmitted from the radio broadcast station; and
an input console configured to provide, responsive to a user input, an instruction to record the current program or the future program.

27. A user interface according to claim 26, further comprising an indicator displayed in association with the current program or the future program in response to recording a respective one of the current program or the future program.
